(19) United States
(12) Patent Application Publication
(10) Pub. No.: US 2002/0005433 A1
(43) Pub. Date: Jan. 17, 2002

(54) NON-CONTACT IC CARD

(76) Inventors: HIDEO NOCHI, FUKUSHIMA-SHI (JP); KAZUTO KOKUBO, TOKYO (JP)

Correspondence Address: FOLEY & LARDNER, 3000 K STREET N W, P O BOX 25696 SUITE 500, WASHINGTON, DC, 200078696

(21) Appl. No.: 09/226,608

(22) Filed: Jan. 7, 1999

(30) Foreign Application Priority Data
Jan. 7, 1998 (JP) 10-001874

(51) Int. Cl. G06K 19/06

(52) U.S. Cl. 235/492

(57) ABSTRACT

A non-contact IC card comprising a one turn. loop antenna pattern provided on a substrate is provided which, in a non-contact manner, transmits information to exterior and receives information therefrom, and in addition can obtain an electric powder from an electric wave transmitted from exterior. By virtue of this constitution, the non-contact IC card, in a for in accordance with ISO, can transmit and receive signals while supplying an electric power for use in the non-contact IC card, even in the case of a frequency of a carrier of ten-odd MHz.

### FIELD OF THE INVENTION

The invention relates to a non-contact IC card, and more particularly to a non-contact IC card in a firm according to ISO (international Organization for standardization) standards.

### BACKGROUND OF THE INVENTION

At the outset, conventional non-contact IC cards will be explained. [First conventional non-contact IC card]

FIG. 1 is a block diagram showing a first conventional non-contact IC card.

The non-contact IC card shown in FIG. 1 is applied to ticket gate apparatuses installed in ticket gates of stations and the like. In FIG. 1, numeral 40 designates a non-contact IC card, and numeral 50 a ticket gate apparatus.

The non-contact IC card 40 comprises: semiconductor integrated circuits, such as a rectification circuit 21, a power circuit 22, a detection circuit 23, and a modulator-demodulator circuit 24; and an antenna. In this non-contact IC card 40, the antenna receives and rectifies an electric wave transmitted from the exterior to obtain an electric power. For the non-contact IC card 40, which receives an electric power from an electric wave transmitted from the exterior, an antenna 19a for obtaining electric power and an antenna 19b for receiving and transmitting data are provided independently of each other.

Since the antenna 19a for obtaining an electric power and an antenna 19b for receiving and transmitting data are provided independently of each other, receipt and transmission of data can be carried out by the antenna 19 while an electric power necessary for the operation of the non-contact IC card is supplied through the antenna 19a.

FIGS. 2A and 2B show the construction of the antennas 19a, 19b, wherein FIG. 2A is a top sectional view of the non-contact IC card and FIG. 2B is a side sectional view of the non-contact IC card. FIGS. 2A and 2B, numeral 19 designates A coil corresponding to antennas 19a, 19b. As shown in FIGS. 2A and 2B, the coil 19 has a structure comprising a pattern having a small line width turned by several times to several tens of times in a loop form. The non-contact IC card is in the form of a rectangular parallelepiped, and the coil 19 is disposed in the interior thereof.

The antenna 19a and the antenna 19b maybe disposed so that the coil 19 is independently or concentrically arranged in a planar direction of the non-contact IC card, or alternatively the coil portion is stacked in the thickness wise direction. The antenna may be in the form of a coil, as well as a plate or a tube, For details of the first conventional non-contact IC card shown in FIGS. 1, 2A, and 2B, reference maybe made to Japanese Patent Laid-Open No. 1968/1997. [Second conventional non-contact IC card]

FIG. 3 is a block diagram showing a second conventional non-contact IC card.

In FIG. 3, numeral 100 designates a non-contact IC card, and numeral 200 a communication device for communication with the non-contact IC card.

In this second conventional non-contact IC card, as shown in FIG. 3, a loop antenna 130 is provided in a non-contact IC card 100, and data for communication with the communication device 200 are received from an electric wave received by the loop antenna 130.

The power controller 140 obtains an electric power for operating each section within the non-contact IC card 100 from the electric wave received by the loop antenna 130.

Thus, in the second conventional non-contact IC card, only the loop antenna 130 functions to receive data from the communication device 200 and transmit data thereto and, at the same time, to obtain an electric power for operating each section at the non-contact IC card from the received electric wave.

For details of the second conventional non-contact IC card shown in FIG. 3, reference may be made to Japanese Patent Laid-Open No. 181728/1996.

In the conventional non-contact IC card, the antenna has a structure comprising a coil pattern having a small line width of not more than 1 mm turned by several times to several tens of times in a loop form.

The antenna circuit comprising a coil pattern having a small line width of not more than 1 mm turned by several times to several tens of times in a loop form, however, disadvantageously creates power loss by a plurality of resonances due to parasitic capacitance between adjacent patterns, skin effect, and proximity effect.

Therefore, in the prior art, when an electric power used in the non-contact IC card at a frequency of no more than several hundreds of kHz is transmitted in a non-contact manner from an external apparatus to the non-contact IC card, the electric power used in the non-contact IC card could have been obtained from the antenna circuit comprising a coil pattern having a small line width turned by several tines to several tens of times, at a Frequency of ten-odd MHZ, a satisfactory amount if the electric power for use in the non-contact IC card could not have been taken out.

On the other hand, Japanese Patent Laid-Open No. 180160/1996 and Japanese Utility Model Laid-Open No. 15336/1985 disclose a card having a one turn-loop antenna, wherein the one turn-loop antenna is used to transmit data.

Japanese Patent Laid-Open No. 181728/199 discloses an IC card that transmits electric power and data through one antenna, In an attempt to receive an electric power through the one turn-loop antenna disclosed in Japanese Patent Laid-Open No. 180160/1996 and Japanese Utility Model Laid-Open No. 15336/1985, no satisfactory amount of an electric power can be received due to resistance loss because the pattern width of the loop antenna is generally 0.9 mm or 1 mm.

### SUMMARY OF THE INVENTION

Accordingly, it is an object of the invention to provide a non-contact IC card having one turn-loop antenna for receiving a sufficient amount of an electric power.

According to the invention, a non-contact IC card, comprises.,

an electronic circuit including a power supply circuit provided on a substrate; and

a loop antenna for providing an electric power to said power supply circuit in accordance with receipt of an electric wave transmitted from exterior, and for transmitting information to exterior and receiving information therefrom;

wherein said loop antenna is patterned to provide one turn on said substrate by a width of 3 mm to 15 mm and a thickness of less than 0.5 mm.

When the width of the pattern of the loop antenna is less than 3 mm, the resistance loss is so large that a sufficient amount of an electric power cannot be received. On the ether hand, when the width of the pattern is more than 15 mm, the antenna does not function as the loop antenna, because the area of the substrate is limited A thickness exceeding 0.5 mm creates a waste of the pattern material because the current flows only on the surface due to the skin effect.

### BRIEF DESCRIPTION OF THE DRAWINGS

The invention will be described in more detail in conjunction with appended drawings, wherein:

FIG. 1 is a block diagram showing a first conventional non-contact IC card;

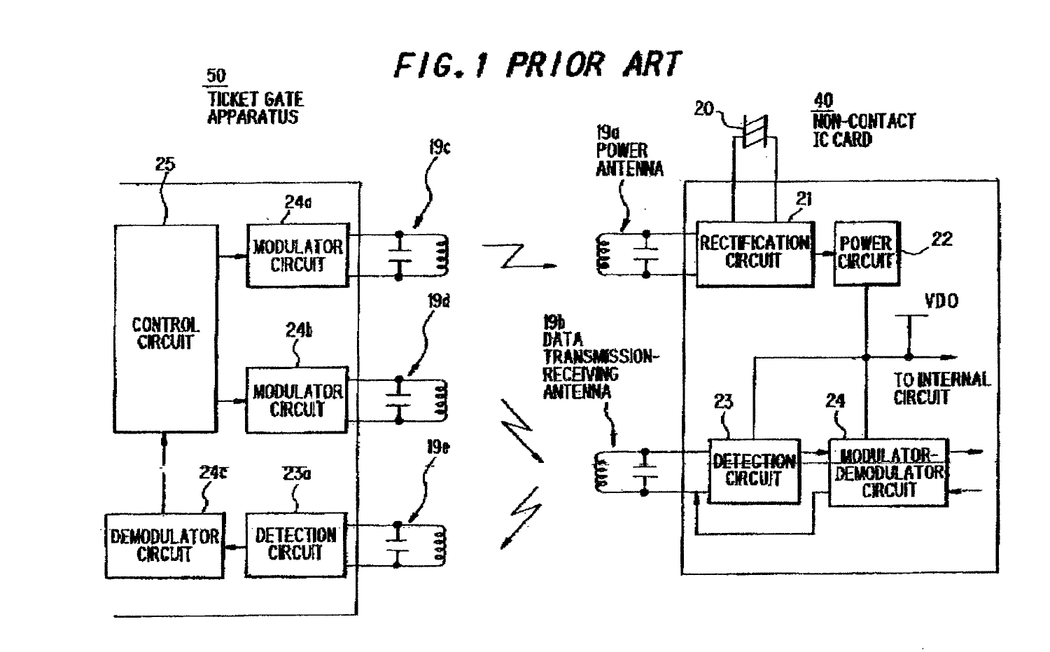

FIGS. 2A and 2B are diagrams showing the construction of the antennas 19a, 19b, wherein FIG. 2A is a top sectional view of the non-contact IC card and FIG. 2B is a side sectional view of the non-contact IC card;

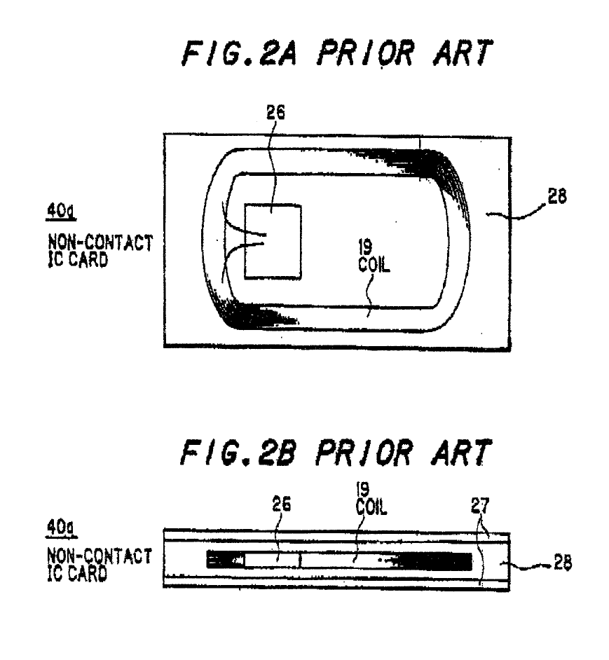

FIG. 3 is a block diagram showing a second conventional non-contact IC card:

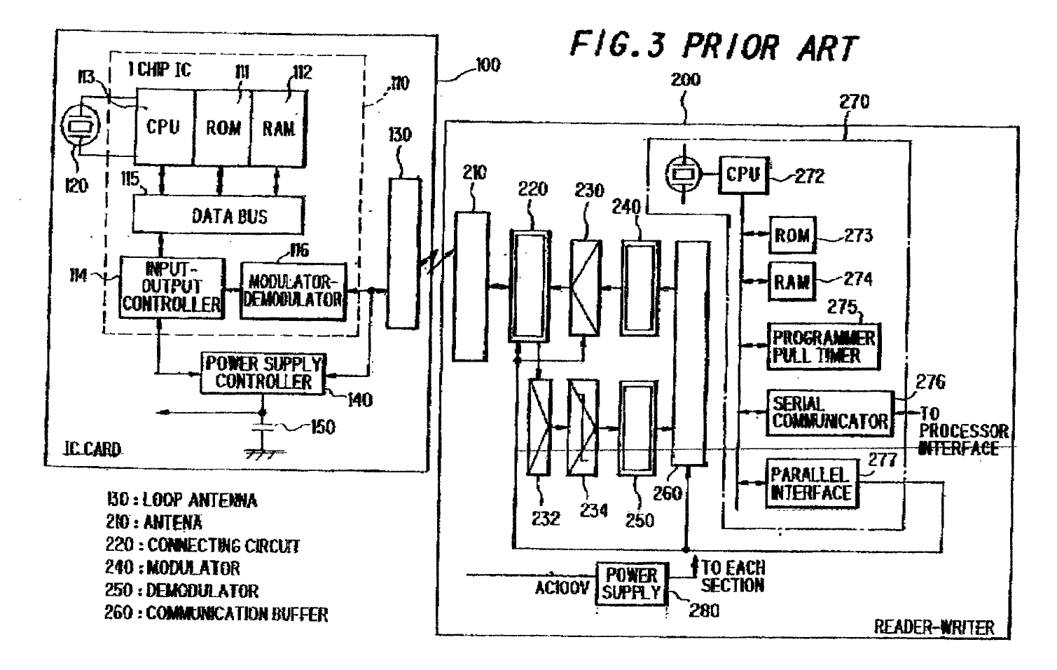

FIGS. 4A and 4B are diagrams showing the construction of a non-contact IC card according to one preferred embodiment of the invention, wherein FIG. 4A is a side sectional view of the non-contact IC card and FIG. 4B is a top sectional view of the non-contact IC card;

FIG. 5 is a block diagram showing an electrical equivalent circuit of a non-contact IC card according to one preferred embodiment of the invention;

FIGS. 6A and 6B are diagrams showing another mounting example of a non-contact IC card according to one preferred embodiment of the invention, wherein FIG. 6A is a top sectional view and FIG. 6B is a side sectional view;

FIG. 7 is an exploded perspective view of another mounting example of a non-contact IC card according to one preferred embodiment of the invention; and

Fig. 8 is a diagram showing the relationship between the voltage generated in an antenna of an IC card and the distance of a transmitter from the IC card.

### DETAILED DESCRIPTION OF THE PREFERRED EMBODIMENTS

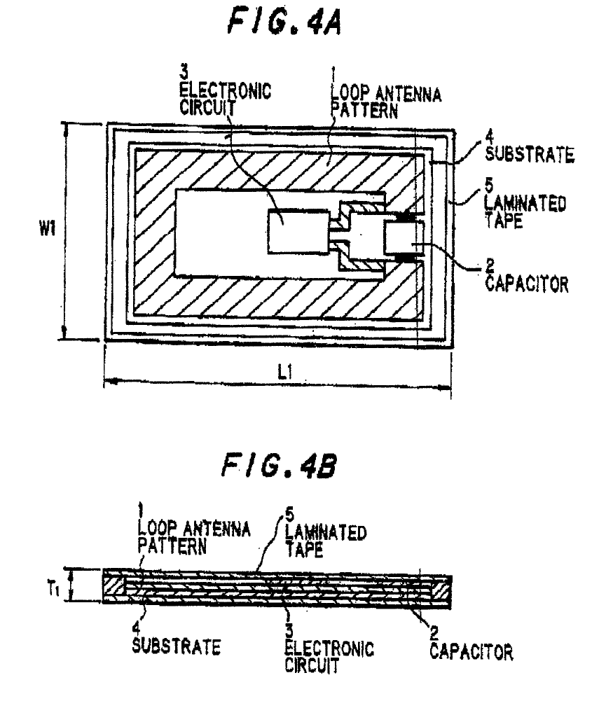

FIGS. 4A and 4B are diagrams showing the construction of a non-contact IC card according to one preferred embodiment of the invention, wherein FIG. 4A is a side section 1 view of the non-contact IC card and FIG. 4B is a top sectional view of the non-contact IC card.

In FIGS. 4A and 4B, numeral 4 designates a substrate, and one turn-loop-antenna pattern 1 is provided on the surface of the substrate 4. The loop antenna pattern 1 has a width of 3 to 15 mm and a thickness of not more than 0.5 mm. Numeral 5 designates a laminated tape surrounding the whole assembly.

A capacitor 2 is connected to the terminal of the one turn loop antenna pattern 1, and a resonance circuit is constituted by the parasitic inductance of the loop antenna pattern 1 and the capacitance of the capacitor 2 to increase the voltage generated in the one turn-loop antenna pattern 1.

An electronic circuit 3 is connected the loop antenna pattern 1. This construction permits an electric power used within the electronic circuit 3 to be supplied from the loop antenna pattern 1 and, at the same time, signals to be transmitted and received.

The substrate 4 mounted with the loop antenna pattern 1, the capacitor 2, and the electronic circuit 3 is sandwiched between upper and lower decorative sheets. The IC card has a dimension of 86 mm in length L1, 54 mm in width W1, and 0.76 mm in thickness T1. This dimension is in accordance with ISO standards

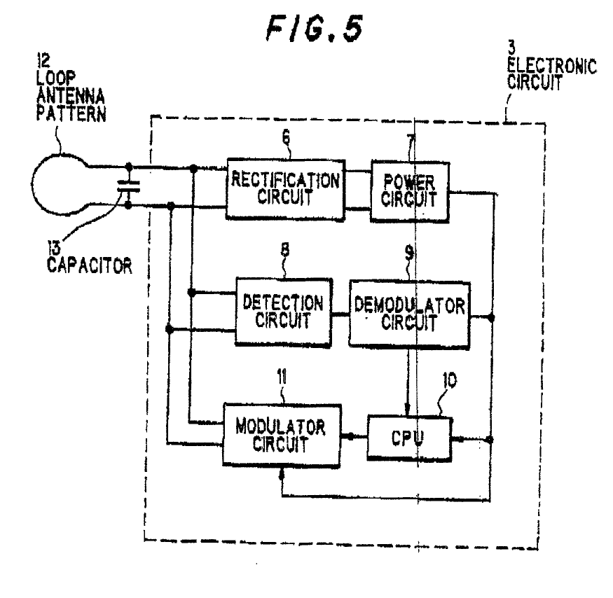

FIG. 5 is a block diagram showing an electrical equivalent circuit of a non-contact IC card according to one preferred embodiment of the invention.

In FIG. 5, numeral 12 designates a one turn-loop antenna pattern which corresponds to the loop antenna pattern 1 shown in FIGS. 4A and 4B. Numeral 13 designates a capacitor which corresponds to the capacitor 2 shown in FIGS. 4A and 4B. In FIG. 5, numeral 3 designates an electronic circuit which corresponds to the electronic circuit 3 shown in FIGS. 4A and 4B.

As shown in FIG. 5, the capacitor 13 is connected to the terminal of the loop antenna pattern 12 to increase the voltage generated in the loop antenna pattern 12. The electronic circuit 3 is connected behind the capacitor 13.

The electronic circuit 3 comprises: a rectification circuit 6 for taking an electric power out of an electric wave received by the loop antenna pattern 12; and a power supply circuit 7 for stabilizing the voltage.

The electronic circuit 3 further comprises: a detection circuit 8 for detecting a received signal; a modulation circuit 9 for demodulating a detected signal; CPU 10 for giving an instruction of signal processing or transmitted data upon receipt of a signal from the demodulation circuit 9; and a modulation circuit 11 for modulating a signal from CPU 10.

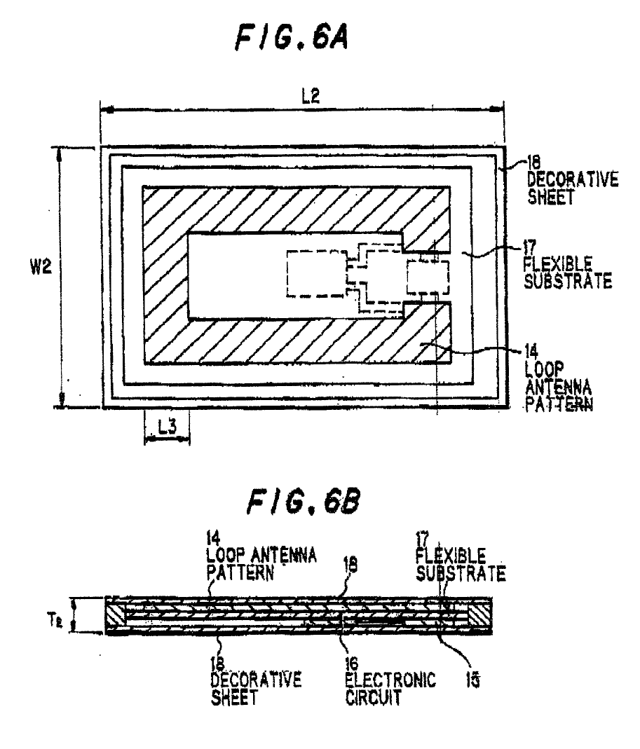

The electronic circuit 3 may be constituted by one-chip semiconductor integrated circuit. Figs, 6A and 6B are diagrams showing another mounting example of a non-contact IC card according to one preferred embodiment of the invention, wherein FIG. 6A is a top sectional view and FIG. 6B is a side sectional view.

Also in the non-contact TC card shown in FIGS. 6A and 6B, the outside dimension is 86 mm in length L2, 54 mm in width W2, and 0.76 mm in thickness T2.

In FIGS. 6A and 9B, numeral 17 designates a flexible substrate, and a loop antenna pattern 14 having a patten width L3 of 10 mm and a thickness of 0.25 mm is provided in a open-turn loop form on the flexible substrate 17. This pattern may be lade of gold, silver, or copper, the material may be properly selected by taking into consideration cost and applications.

A resonance capacitor 15 is provided on the surface of the flexible substrate 17 remote from the loop antenna pattern 14 and is connected to the terminal of the loop antenna pattern 14.

The capacitance of the resonance capacitor 15 is determined so as to satisfy the following equation:

f=1/(2π√(LC)) (1)

wherein C represents the capacitance of the resonance capacitor 15, L represents the inductance of the one turn-antenna pattern 14, and f represents the frequency of a carrier transmitted to the non-contact IC card.

The electronic circuit 16 is mounted on the substrate in its side where the resonance capacitor 15 has been formed, and the electronic circuit 16 is connected to the loop antenna pattern 14.

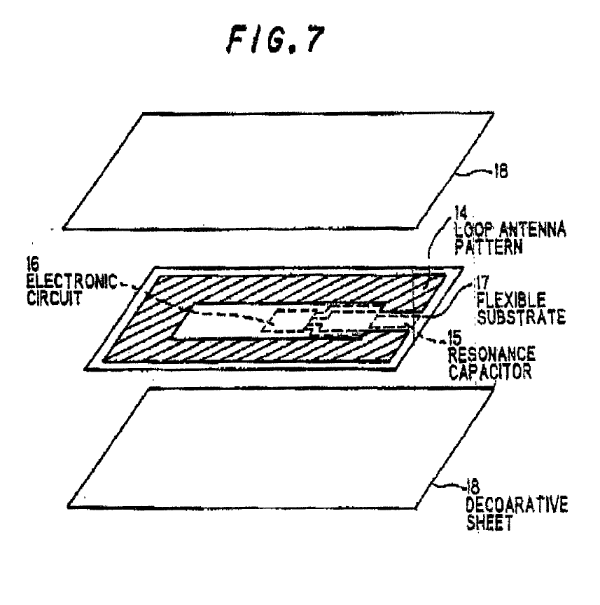

FIG. 7 is an exploded perspective view of another mounting example the non-contact IC card according to the one preferred embodiment of the invention.

As shown in FIG. 7, a flexible substrate 17, a one turn-loop antenna pattern 14 mounted on the flexible substrate 17, a resonance capacitor 15, and an electronic circuit 16 is sandwiched between decorative sheets 18. This decorative sheet maybe constituted, for example, by a plastic film.

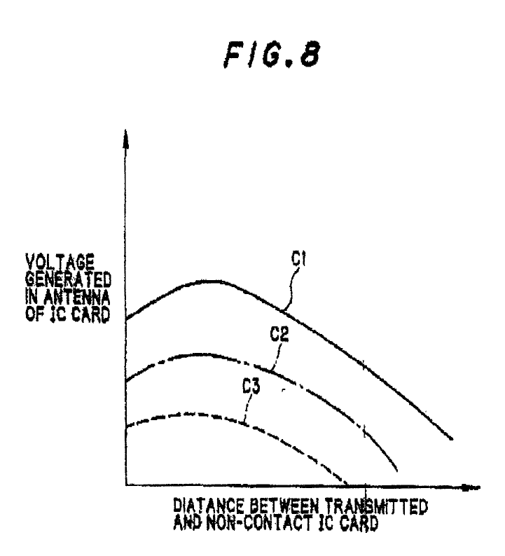

FIG. 8 is a diagram showing the relationship between the voltage generated in an antenna of an IC card and the distance of a transmitter from the IC card.

In FIG. 8, a curve C3 shows the results in a structure, used in the conventional IC card, comprising a fine pattern having a line width of not more than 1 mm turned by several times to several tens of times in a loop form.

A curve C2 shows the results on the construction according to one preferred embodiment of the invention using one turn-antenna pattern having a dimension of 3 to 15 mm in pattern width and not more than 0.5 mm in thickness.

A curve C1 shows the results on a structure wherein a resonance capacitor 2 or a resonance capacitor 15 has been provided on the above antenna pattern.

The results shown in FIG. 8 are for the case where the non-contact IC card receives a frequency of carrier of ten-odd MHz.

In the antenna circuit of the conventional non-contact IC card, the voltage generated in the antenna at a frequency of a carrier of ten-odd MHz is small (the curve C3 in the drawing). On the other hand, the one turn-antenna pattern having a dimension of 3 to 15 mm in pattern width and not more than 0.5 mm in thickness according to the one preferred embodiment of the invention can withdraw a large voltage (the curve C2 in the drawing). Further, resonance using the resonance capacitor 15 enables a larger voltage to be withdrawn (the curve C3 in the drawing).

As described above, according to the invention, the adoption of a one turn-loop antenna pattern can prevent power loss caused by a plurality of resonances due to parasitic capacitance between adjacent patterns, skin effect, and proximity effect. Therefore, even when the non-contact IC card using a carrier frequency of ten-odd MHz is away from the transmitter, a large amount of electric power can be advantageously taken out within the IC card.

An antenna pattern having a dimension of 3 to 15 mm in width and not more than 0.5 mm in thickness can advantageously provide the above effect and, in addition, enables the preparation of non-contact IC cards in accordance with ISO standards.

The invention has been described in detail with particular reference to preferred embodiments, but it will be understood that variations and modifications can be effected within the scope of the invention as set forth in the appended claims.

What is claimed is:

1. A non-contact IC card, comprising:
an electronic circuit including a power supply circuit provided on a substrate; and
a loop antenna for providing an electric power to said power supply circuit in accordance with receipt of an electric wave transmitted from exterior, and for transmitting information to exterior and receiving information therefrom;
wherein said loop antenna is patterned to provide one turn on said substrate by a width of 3 mm to 15 mm and a thickness of less than 0.5 mm,

2. The non-contact IC card as defined in claim 1, wherein:
said loop antenna is connected to a capacitor inserted between both terminals thereof, said both terminals of said loop antenna being connected to a rectifying circuit connected to said power supply circuit.

3. The non-contact IC card as defined in claim 2, wherein:
said capacitor is provided on a plane of said substrate on which said loop antenna is patterned.

4. The non-contact IC card as defined in claim 2, wherein:
said capacitor is provided on a plane opposite to a plane on which said loop antenna is patterned.
